(19) United States
(12) Patent Application Publication
(10) Pub. No.: US 2008/0169747 A1
(43) Pub. Date: Jul. 17, 2008

(54) DISPLAY DEVICE USING LIGHT STORAGE MATERIAL AND METHOD OF MANUFACTURING THE SAME

(75) Inventor: Keiji IZUMI, Osaka-shi (JP)

Correspondence Address: MORRISON & FOERSTER LLP, 1650 TYSONS BOULEVARD, SUITE 400, MCLEAN, VA, 22102, US

(73) Assignee: Aya Izumi, Osaka-Shi (JP)

(21) Appl. No.: 11/964,536

(22) Filed: Dec. 26, 2007

(30) Foreign Application Priority Data
Dec. 25, 2006 (JP) 2006-348162
Jan. 16, 2007 (JP) 2007-006582

(51) Int. Cl. H05B 33/00; H01J 9/00

(52) U.S. Cl. 313/483; 445/24

(57) ABSTRACT

A display device has a configuration in which a translucent white filling material and a powder particle light storage material are mixed and filled in a space formed by sandwiching a spacer plate having a predetermined thickness between a display plate and a reflector plate. Light emitted by particles of the light storage material is scattered by the translucent white filling material. Thus, high luminance light can be evenly emitted from the entire surface of the display plate. Moreover, viscosity of the filling material enables manufacturing while maintaining a state where the particles of the light storage material are averagely dispersed. Accordingly, the device can be manufactured by use of the spacer plate having a large thickness. Consequently, a display device having high luminance and a long light emission time can be provided by filling a large amount of the light storage material.

This application claims priority from Japanese Patent Application Number JP2006-348162 filed on Dec. 25, 2006, and JP2007-006582 filed on Jan. 16, 2007, content of which are incorporated herein by reference in its entirety.

### BACKGROUND OF THE INVENTION

1. Field of the Invention

The present invention relates to a display device using a light storage material and a method manufacturing the display device using a light storage material.

2. Description of the Related Art

Display devices, signs and the like which can deliver definite information to viewers even at night or in dark places are utilized for various applications. Above all, a light storage material which is irradiated with light, stores energy of the light and emits light by itself requires no power source and thus is attracting attention from the viewpoint of energy saving. There has been advanced practical application of display devices or signs using the light storage material. As the display device or the like using such a light storage material, the following various devices have been developed.

The invention described in Japanese Patent Application Publication No. 2001-51632 is an emergency exit sign having a sign plate fittingly fixed to an opaque resin plate. Specifically, the sign plate is obtained by mixing and kneading a light storage material into transparent resin such as ABS resin, AS resin and styrol resin and by forming the mixture into a desired shape.

The invention described in Japanese Patent Application Publication No. 2002-328634 is a light storage display board obtained in the following manner. Specifically, concave grooves are provided in a surface of a metal substrate, and a white paint is applied to a concave part. Thereafter, the concave grooves are filled with a mixture of more than one metal compound or rare earth material and a vehicle. Subsequently, the resultant structure is calcined to obtain the light storage display board. By completely filling the concave grooves with the light storage material, a bright display board is obtained. Moreover, formation of a film by calcining titanium oxide on the substrate surface reduces adhesion of dirt and dust.

The invention described in Japanese Patent Application Publication No. 2003-131599 is a display board obtained by spreading light storage particles and glass cullet on a frame member with a bottom having a desired shape and by bonding a rim of the frame member to a plate-like member. The light storage particles are not fixed to the frame member and the plate-like member. Accordingly, the light storage particles can be taken out when display contents are to be changed and can be reused by being put into a desired frame member again.

The invention described in Japanese Patent Application Publication No. Hei 11-350804 is a door knob cover having enhanced visibility at night. A material obtained by mixing a light storage material into translucent white silicone rubber is vulcanized and molded into a door knob shape.

In JP-A. 2001-51632, the light storage material is mixed into a hard resin material such as the ABS resin. When 40% or more of the light storage material is mixed into such hard resin, resin molding becomes difficult. Accordingly, there is a problem that a bright emergency exit sign cannot be obtained by increasing the amount of the light storage material.

Moreover, the light storage material is mixed into the transparent resin, and the transparent resin cannot scatter light emitted from the light storage material. Accordingly, there is a problem that light cannot be evenly emitted from the entire surface of the emergency exit sign.

Furthermore, the hard resin is deformed under stress. Since the hard resin has no flexibility, adhesion between the resin and the light storage material is deteriorated and a gap is caused therebetween. As a result, a refractive index of the light is changed to cause a problem that constant luminance can no longer be achieved.

In JP-A. 2002-328634, the light storage material is generated directly in the concave grooves provided in the substrate by calcining the substrate after the concave grooves are filled with a raw material. For this reason, a metal plate that can endure a high temperature of 1000° C. or higher has to be used as the substrate. Moreover, although concave grooves having a predetermined display shape have to be generated, groove processing of the metal plate is difficult. Consequently, there is a problem that easy manufacturing of a desired display board is difficult.

In JP-A. 2003-131599, the light storage particles and the glass cullet are merely spread on the frame member. Thus, the light storage particles are not evenly dispersed. As a result, there is a problem that light emission from the display surface becomes uneven.

Moreover, a filling material that covers the light storage particles is not provided in the frame member, and light emitted from the light storage particles cannot be scattered. Thus, there is a problem that light cannot be evenly emitted from the entire display surface.

In JP-A. Hei 11-350804, the door knob cover is formed by use of the translucent white silicone rubber, and is to be put on a door knob. In order not to impair functions of the cover, only about 10 to 20 of the light storage material can be contained with respect to 100 of the silicone rubber.

Moreover, since the knob cover is put on the door knob, the cover is required to be stretchable and has to maintain an easy-to-use original size of the door knob. Accordingly, the cover has to be made with a thickness on the order of 1 mm so as not to impair stretch properties and strength of the silicone rubber. Consequently, the amount of the light storage material cannot be increased relative to the silicone rubber, and the light storage material having a large particle size cannot be used. This produces a problem that a knob cover having high luminance and a long light emission time cannot be made.

Furthermore, since the knob cover lights itself, the knob cover does not include backlight function.

### SUMMARY OF THE INVENTION

A display device of the present invention includes: a transparent display plate having characters, symbols, patterns and the like provided thereon; a reflector plate; a spacer plate which has a predetermined thickness and is provided between the display plate and the reflector plate; and a light emitting layer which is formed of a light storage material and inserted into a space formed by the display plate, the reflector plate and the spacer plate. The light emitting layer is one formed to have a predetermined thickness by mixing a non-transparent filling material with the light storage material. The light storage material is covered with the filling material and set in an averagely dispersed state. Moreover, the light emitting layer is used as a backlight which evenly emits light from the entire surface of the display plate by scattering light emitted from the light storage material in the filling material.

Moreover, in the present invention, a white plate is used as the reflector plate to enhance luminance by reflecting the light emitted from the light storage material.

Furthermore, in the present invention, a translucent white filling material is used as the filling material to scatter the light emitted from the light storage material.

Furthermore, in the present invention, a caulking material or a sealing material is used as the filling material, and the filling material covers the light storage material.

Furthermore, in the present invention, the display plate, the reflector plate and the spacer plate are made of any of resin and glass so as to have mechanical strength, and the light emitting layer is thickly formed so as to sufficiently contain the light storage material while having no mechanical strength.

Furthermore, the display device of the present invention further includes, a light guide plate provided between the light emitting layer and the reflector plate; a light emitting element housing part provided so as to be closely attached to the light guide plate; and a light emitting element provided in the light emitting element housing part so as to face the light guide plate. The light emitting layer is formed to have approximately the same size as that of the light emitting element housing part, and evenly emits light from the entire surface of the display plate while allowing the light storage material to constantly store light from the light emitting element.

A display device of the present invention includes, a first transparent display plate; a second transparent display plate; a spacer plate which has a predetermined thickness and is provided between the first and second display plates; and a light emitting layer which is formed of a light storage material and inserted into a space formed by the first and second display plates and the spacer plate. On one of or both of the first and second display plates, characters, symbols, patterns and the like are provided. The light emitting layer is one formed to have a predetermined thickness by mixing a non-transparent filling material with the light storage material. The light storage material is covered with the filling material and set in an averagely dispersed state. Moreover, the light emitting layer is used as a backlight which evenly emits light from the entire surface of the display plate by scattering light emitted from the light storage material in the filling material.

Furthermore, in the present invention, the light storage material and the filling material are mixed and filled in the space after particles of the light storage material are covered with the filling material and averagely dispersed in the filling material by viscosity thereof.

Furthermore, in the present invention, the space formed by attaching the spacer plate having a predetermined thickness to the first display plate is filled with a mixture of the light storage material and a filling material having elasticity even when cured. Thereafter, the mixture of the light storage material and the filling material is planarized so as to correspond to the thickness of the spacer plate. Subsequently, the second display plate is attached while leaving the elasticity of the filling material after curing the filling material by volatilizing volatile components therein.

### BRIEF DESCRIPTION OF THE DRAWINGS

FIGS. 1A and 1B are perspective views showing external appearances of display devices according to the present embodiment.

FIGS. 2A and 2B are cross-sectional views showing internal structures of the display devices according to the present embodiment.

FIG. 3 is a perspective view showing an external appearance of a display device having a lighting unit installed therein according to the present embodiment.

FIG. 4 is a cross-sectional view showing an internal structure of the display device having the lighting unit installed therein according to the present embodiment.

FIGS. 5A to 5D are process views showing a method for manufacturing a display device according to the present embodiment.

FIGS. 6A to 6C are graphs each showing a relationship between light emission time and luminance in a display device formed by use of a light storage material having a single particle size according to the present embodiment.

FIGS. 7A to 7C are graphs each showing a relationship between light emission time and luminance in a display device formed by use of a combination of several light storage materials having different particle sizes according to the present embodiment.

FIGS. 8A to 8C are graphs each showing a relationship between light emission time and luminance in a display device according to the present embodiment.

### DESCRIPTION OF THE EMBODIMENTS

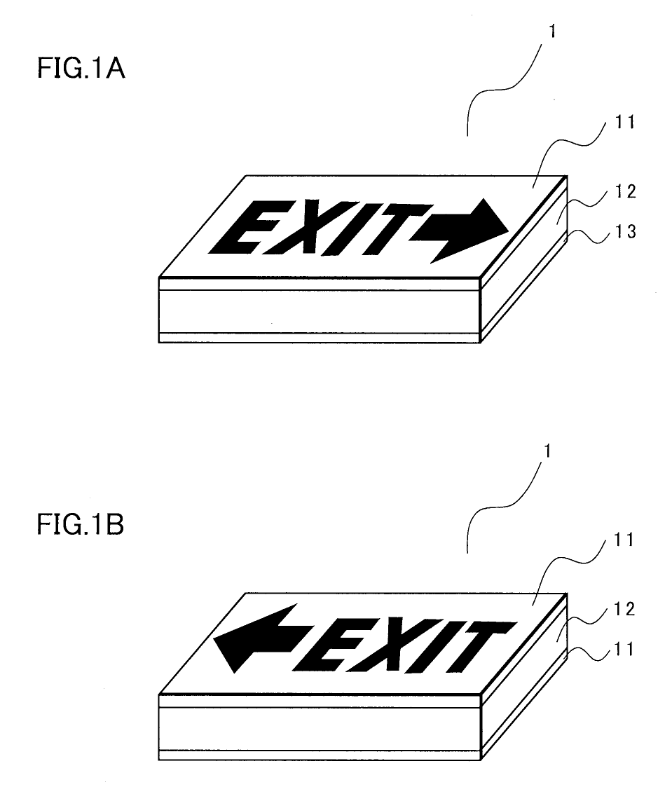

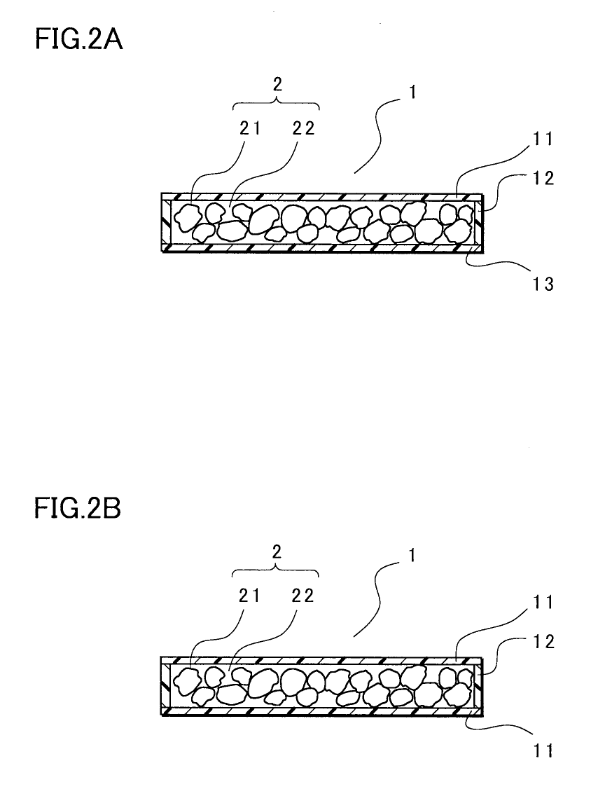

With reference to FIGS. 1A and 1B, display devices according to the present embodiment will be schematically described. FIG. 1A shows a single-sided light emitting display device 1 using a reflector plate 13. FIG. 1B shows a double-sided light emitting display device 1 using a display plate 11 instead of the reflector plate 13. As shown in FIG. 1A, the single-sided light emitting display device 1 of the present embodiment has a configuration in which a frame-shaped spacer plate 12 is sandwiched between the display plate 11 and the reflector plate 13. Into an internal space thus formed, a light emitting layer 2 is inserted, which is formed by mixing a light storage material 21 (see FIGS. 2A and 2B) and a filling material 22 (see FIGS. 2A and 2B).

A transparent plate is used as the display plate 11, and characters, symbols, patterns and the like are drawn on a rear or front surface thereof. Thus, light emitted from the light emitting layer 2 is efficiently released to the outside so that a viewer can easily recognize the display device.

The spacer plate 12 is formed to have a frame shape, and a plate having a desired thickness can be used as the spacer plate 12. The more the thickness of the spacer plate 12 is increased, the more light storage material 21 can be filled. Thus, the display device 1 with high luminance can be obtained. Moreover, it is also possible to the form the spacer plate 12 into a circular shape, a star shape or the like and to obtain the display device 1 having such a shape. The spacer plate 12 can be prepared by punching a plate material having a predetermined thickness to have a frame shape, by bonding plate materials or by using a die such as injection molding.

The reflector plate 13 enhances the luminance by reflecting light emitted from the light storage material 21 in the light emitting layer 2. In order to improve reflection characteristics, preferably a non-transparent plate, more preferably a white plate is used as the reflector plate 13.

Although the materials of the display plate 11, the spacer plate 12 and the reflector plate 13 are not particularly limited, it is preferable to use hard resin such as polycarbonate resin, acrylic resin, PET resin and vinyl chloride resin or to use glass such as tempered glass. The polycarbonate resin has good strength and thus enhances the strength of the display device 1. Moreover, the polycarbonate resin is suitable because of its resistance to cracking even when used in places undergoing impact on a daily basis, such as a hallway in a building or a passageway at a station. Moreover, the acrylic resin and the like facilitate application of titanium oxide. The titanium oxide functions as a photocatalyst and can remove dirt adhering to the display device 1 by its natural power. Thus, there is no need to clean up the display device 1 and deterioration in visibility of the display device 1 due to dirt and the like can be suppressed.

Moreover, as shown in FIG. 1B, instead of the reflector plate 13, a transparent display plate 11 may be used. FIG. 1B shows a back side of the display device 1, and the same characters and the like as those shown in FIG. 1A are provided on the display plate 11 on a front side thereof. Accordingly, the display device 1 has a configuration in which a frame-shaped spacer plate 12 is sandwiched between the two transparent display plates 11. Particularly, by forming a configuration in which the characters and the like are provided on both of the two transparent display plates 11, light is emitted from both sides of the display device 1. Thus, contents such as the characters can be made visible from either side. Also in this case, materials of the display plates 11 and the like are as described above.

With reference to FIGS. 2A and 2B, description will be given of internal structures of the display devices according to the present embodiment. In the single-sided light emitting display device 1 shown in FIG. 2A, as described above, the light emitting layer 2 formed of the light storage material 21 and the filling material 22 is inserted into the space formed by the display plate 11, the spacer plate 12 and the reflector plate 13. Moreover, particles of the light storage material 21 are covered with the filling material 22 and arranged while being averagely dispersed. Accordingly, light emitted from the light storage material 21 is scattered in the filling material, and the light is evenly emitted from the entire surface of the display plate 11. Thus, the light emitting layer 2 has a function as a backlight.

A powder particle material is used as the light storage material 21, and there is no limitation on a particle size. In the present embodiment, the spacer plate 12 having a desired thickness can be used. Thus, when the light storage material having a large particle size is to be used, the spacer plate 12 having a large thickness may be used. Since the spacer plate 12 having a large thickness can be used, more light storage material can be filled. Thus, the display device 1 having high luminance can be provided.

Moreover, in the present embodiment, as described later, the filling material 22 and the light storage material 21 are merely mixed and filled in the space formed by attaching the spacer plate 12 to the reflector plate 13. Therefore, the display device can be easily manufactured even if a large amount of the light storage material 21 is filled. Thus, it is possible to set the amount of the light storage material 21 to 50 wt % of the light emitting layer 2 or more. Consequently, the display device 1 having high luminance can be obtained.

As to the light storage material 21, a pellet obtained by calcining aluminum oxide as a parent body, other oxides, rare earth elements and the like is crushed and separated into particles having various particle sizes by a centrifugal separator. The light storage material 21 having any of the particle sizes may be used. Moreover, the light storage material having a single particle size may be used or light storage materials having different particle sizes may be combined and used.

There are light storage materials 21 having various emission colors such as blue, green and orange, any of those may be used.

As the filling material 22, a translucent white material is suitably used. The use of the translucent white filling material 22 makes it easy for the light emitted from the light storage material 21 to be scattered in the filling material 22. Accordingly, the light is evenly emitted from the entire light emitting layer 2. Thus, even light emission can be obtained from the entire surface of the display plate 11. Particularly, when the light storage material 21 having a large particle size is used, gaps between the respective particles of the light storage material 21 are increased in size. As a result, the surface of the display plate 11 becomes partially bright. Consequently, the even light emission can no longer be obtained from the display plate 11. However, since the translucent white filling material 22 efficiently scatters the light, the light can be evenly emitted from the entire surface of the display plate 11.

Moreover, when the light storage material 21 having a large particle size is used, a rice-grain pattern of the light storage material 21 is visible from a transparent portion of the display plate 11. Thus, visual quality is impaired. However, since the filling material 22 is translucent white, an external appearance of the light storage material 21 is made less visible even when no light is emitted in daylight. Thus, there is an advantage that a good appearance is achieved.

As the filling material 22, a caulking material or a sealing material is preferably used. Particularly, a material that does not lose its elasticity even when cured is preferable, such as acrylic series, urethane series, silicon series and polysulfide series. Since the filling material 22 does not lose its elasticity, the light storage material 21 can be maintained constantly in a state of being covered with the filling material 22 even under a stress, a thermal change and the like. Accordingly, since no air enters the light emitting layer 2, there is no influence of light refraction caused by the air. Thus, the even light emission can be constantly obtained from the entire surface of the display plate 11.

The filling material 22 has elasticity even when cured and therefore has poor mechanical strength. Since the light storage material 21 is mixed therewith, the light emitting layer 2 has no supporting function by itself. If the light emitting layer 2 is used as it is, the light storage material 21 is peeled off and the light emitting layer 2 itself is destroyed. However, since the light emitting layer 2 is covered with the display plate 11, the spacer plate 12 and the reflector plate 13, mechanical strength is not required. Particularly, when hard resin such as polycarbonate or glass is used for the display plate 11, the spacer plate 12 and the reflector plate 7. 13, the display device 1 itself is excellent in mechanical strength. As described above, since the light emitting layer 2 itself is not required to have mechanical strength, a large amount of the light storage material 21 can be filled. Hence, it is possible to set the amount of the light storage material 21 to 50 wt % of the light emitting layer 2 or more. Moreover, the light emitting layer 2 having a much larger thickness can also be formed by using the spacer plate 12 having a large thickness. Furthermore, since the light emitting layer 2 having a large thickness can be formed, there is no problem even if the light storage material 21 having a large particle size is filled.

Note that the same goes for the double-sided light emitting display device 1 shown in FIG. 2B, except that the transparent display plate 11 is provided instead of the reflector plate 13.

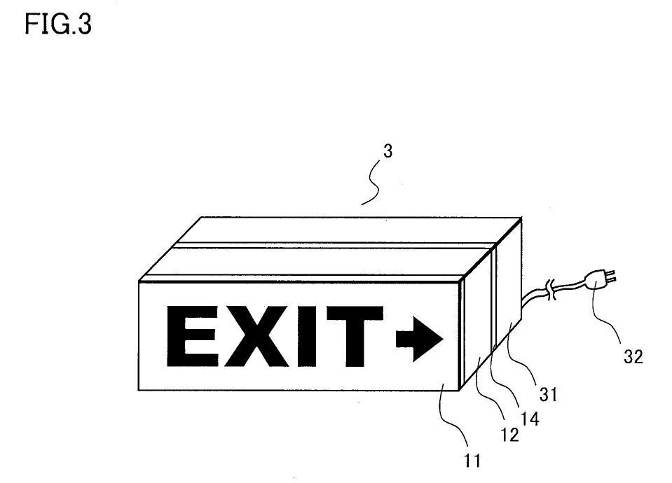

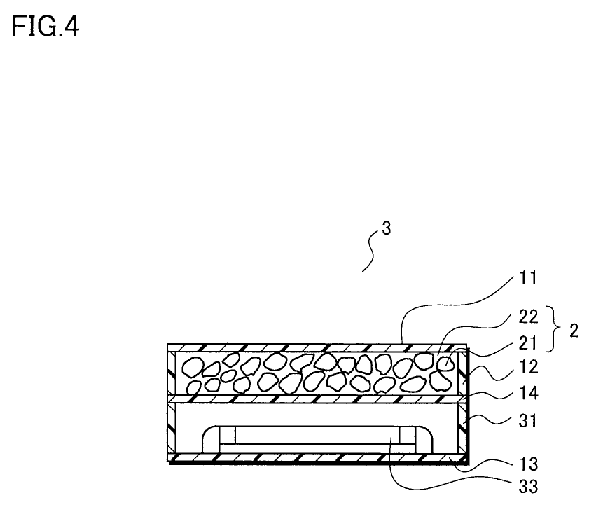

FIG. 3 shows an external appearance of a display device 3 having a lighting unit installed therein, and FIG. 4 shows an internal structure thereof.

As in the internal structure shown in FIG. 4, the display device 3 includes: a light guide plate 14 provided between the light emitting layer 2 and the reflector plate 13 in the display device 1 described above; and a light emitting element housing part 31 provided so as to be closely attached to the light guide plate 14. Moreover, a light emitting element 33 is provided in the light emitting element housing part 31 so as to face the light guide plate 14.

A transparent plate is preferably used as the light guide plate 14 so that light from the light emitting element 33 efficiently passes therethrough to facilitate light storage by the light storage material 21.

The light emitting element 33 receives power supplied from a commercial power source or the like, supplies light and heat to the light storage material 21, and constantly maintains a light storage state of the light emitting layer 2.

The light emitting element housing part 31 is closely attached to the light guide plate 14. Accordingly, air circulation does not occur in a space formed by the light emitting element housing part 31 and the light guide plate 14. Thus, when an ambient temperature in the light emitting element housing part 31 is increased by heat generated by the light emitting element, the light emitting layer 2 is heated to enhance efficiency of light emission from the light emitting layer 2. The ambient temperature is set to about 40° C. depending on use environments.

Moreover, the light emitting element housing part 31 is formed to have approximately the same size as that of the light emitting layer 2. Accordingly, the entire surface of the light emitting layer 2 can be irradiated with light emitted from the light emitting element 33 through the light guide plate 14. Thus, it is possible to allow the light storage material 21 included in the light emitting layer 2 to evenly store light. Similarly, the heat generated by the light emitting element 33 can be transmitted to the entire light emitting layer 2.

As the light emitting element 33, any of the following may be used as long as light can be supplied in a constant light storage state of the light storage material 21. Specifically, it is conceivable to use a fluorescent lamp, an incandescent lamp, a cold-cathode tube or a light emitting diode. Moreover, since the light emitting element 33 enhances luminous efficiency of the light storage material 21 by increasing the ambient temperature in the light emitting element housing part 31. Thus, the fluorescent lamp or the incandescent lamp, which has a higher heating value, is more preferable.

As long as the power is supplied, the light emitting element 33 constantly emits light. Thus, the display device 1 having constant luminance maintained both in the nighttime and in the daytime is formed.

Moreover, the constant light storage state of the light storage material 21 is maintained by the light and heat generated by the light emitting element 33. Thus, when the power goes out or a battery runs out, the light storage material 21 instantly emits light. Consequently, the light can be evenly emitted from the entire surface of the display plate 11.

It is preferable that the inside of the light emitting element housing part 31 and the light guide plate 14 are colored in white or silver. Thus, the light from the light emitting element 33 can be reflected and sufficiently stored by the light storage material 21. Moreover, when the light storage material 21 emits light, luminance can be enhanced by reflecting the light.

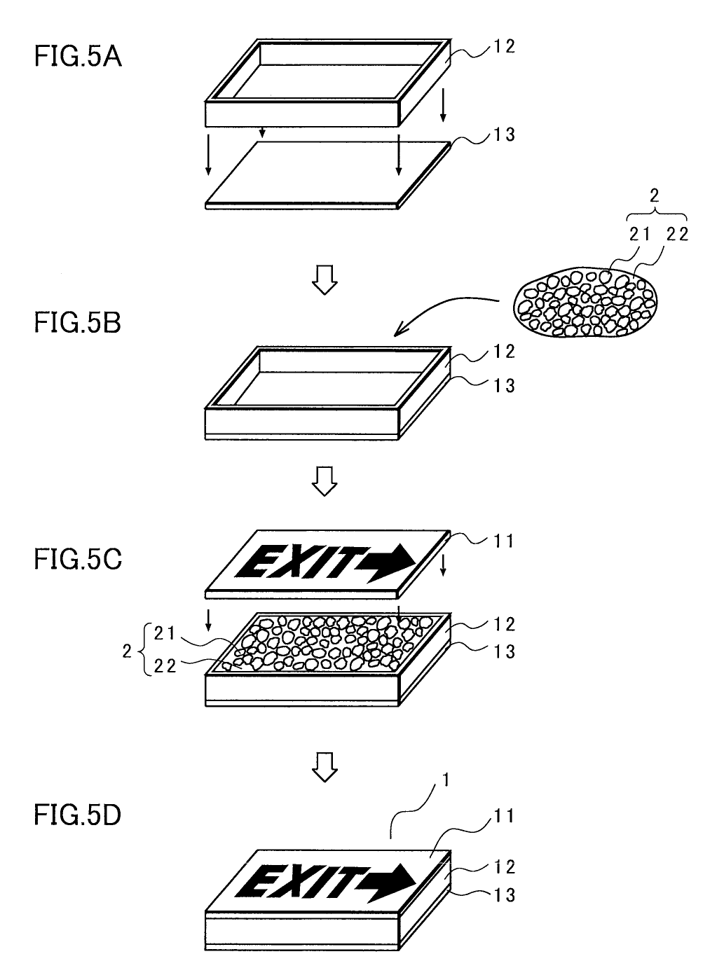

With reference to FIGS. 5A to 5D, description will be given of a method for manufacturing a display device according to the present embodiment.

FIG. 5A shows a step of attaching a frame-shaped spacer plate 12 to a reflector plate 13. For attachment, a commercially available adhesive may be used.

FIG. 5B shows a step of forming a light emitting layer 2. A light storage material 21 and a filling material 22 are mixed. A granular light storage material 21 is used. The light storage material having a single particle size may be used or several light storage materials having different particle sizes may be combined and used. As the filling material 22, a caulking material or a sealing material is used. Since those materials have viscosity before cured, particles of the light storage material 21 are completely covered with the filling material 22. Moreover, since the viscosity of the filling material 22 enhances dispersion of the particles of the light storage material 21, the particles are set in a state of being averagely dispersed. Moreover, since the caulking material and the sealing material have excellent airtightness and water resistance, no bubbles are formed in the filling material 22.

The mixture of the light storage material 21 and the filling material 22 is filled into a space formed by the spacer plate 12 and the reflector plate 13. The viscosity of the filling material 22 maintains the state where the particles of the light storage material 21 are covered with the filling material 22 and averagely dispersed even after filling.

As described above, even if the spacer plate 12 has a large thickness, the viscosity of the filling material 22 maintains the state where the particles of the light storage material 21 are averagely dispersed. Thus, it is possible to use the spacer plate 12 having various thicknesses. By increasing the thickness of the spacer plate 12, the display device 1 having a much larger thickness can be obtained. Thus, the display device 1 having high luminance is obtained by increasing the amount of the light storage material 21.

After filling, the filled mixture of the light storage material 21 and the filling material 22 is planarized so as to correspond to a height of the spacer plate 12. An excess mixture is removed in this event. For planarization, a spatula or the like may be used.

FIG. 5C shows a step of attaching a display plate 11 after drying the light emitting layer 2.

After the light emitting layer 2 is formed, the light emitting layer 2 is dried to volatilize volatile components contained in the filling material 22 and to cure the filling material 22. In the present embodiment, as described above, an acrylic or urethane caulking material that does not lose its elasticity even when cured is used as the filling material 22. Since the filling material 22 has elasticity even when cured, adhesion between the filling material 22 and the light storage material 21 is not impaired.

After the filling material 22 is cured, the transparent display plate 11 having characters and the like provided thereon is attached.

Through the above steps, the display device 1 of the present embodiment is completed as shown in FIG. 5D. Accordingly, the display device 1 having a desired thickness and high luminance can be easily manufactured.

Note that the display device 1 including display plates 11 on both sides without the reflector plate 13 can be manufactured in the same manner by using the display plate 11 having characters provided thereon instead of the reflector plate 13.

### EXAMPLE 1

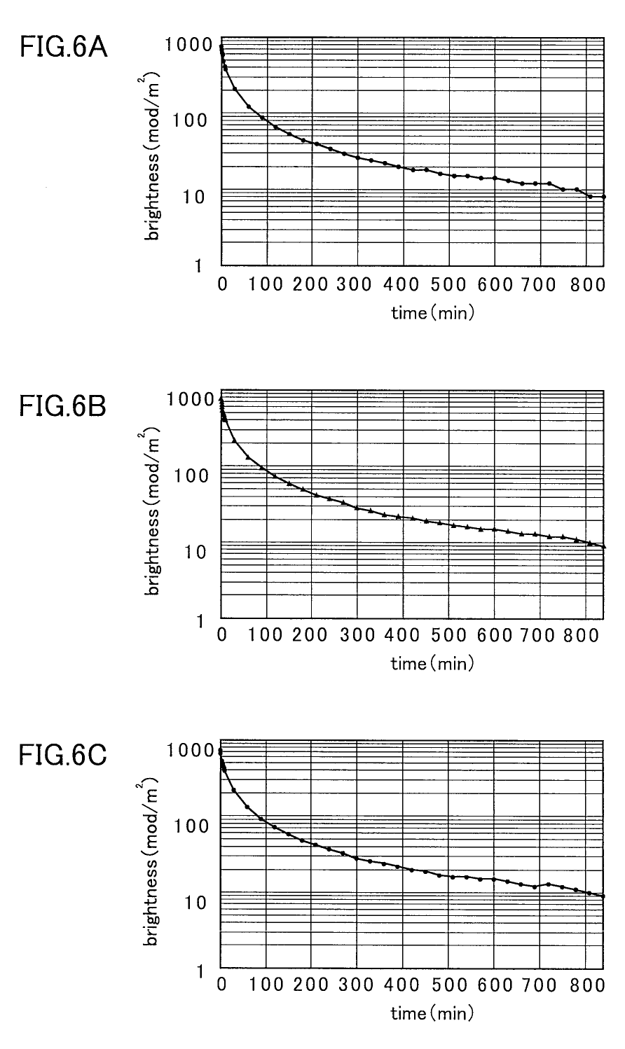

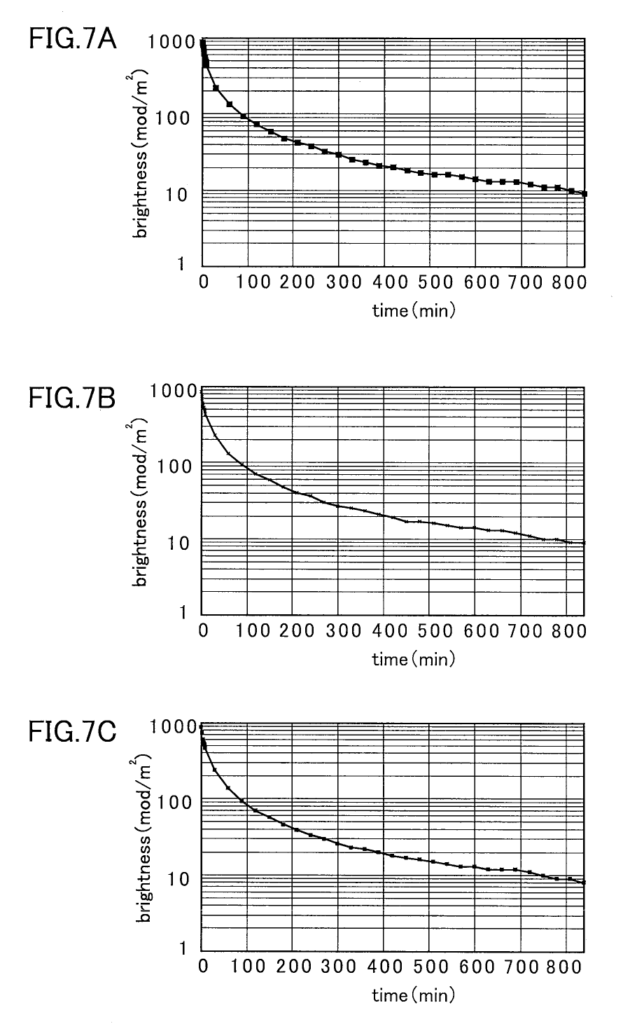

A luminance test is conducted after several light storage materials having different particle sizes are prepared and a display device including a reflector plate on its one side is manufactured by use of the manufacturing method described above. FIGS. 6A to 6C are graphs each showing a relationship between light emission time and luminance in a display device formed by use of the light storage material having a single particle size. FIGS. 7A to 7C are graphs each showing a relationship between light emission time and luminance in a display device formed by use of a combination of several light storage materials having different particle sizes.

As the light storage material, blue color forming light storage materials EZCM (manufactured by EZ BRIGHT CORPORATION) having particle sizes of 150 μm, 1000 μm, 3000 μm and 5000 μm are prepared, respectively. Thereafter, three samples are prepared for each of a display device including the light storage material having a single particle size and a display device including a combination of several light storage materials having different particle sizes.

As the filling material, a translucent white filling material HAMATITE SS-310 (manufactured by The Yokohama Rubber Co., Ltd.) is used. The light storage material contained in each of the samples and the filling material are mixed by a weight ratio of 1:1 and used. A spacer plate having a thickness of 7 mm is used for all the samples, and 3 cm×6 cm plates are used to form a display plate and a reflector plate. Note that a white plate is used as the reflector plate, and a transparent and colorless display plate is used.

After light is shut out from each of the samples for over 24 hours, vertical irradiation is carried out by use of two 40 W fluorescent lamps while keeping a distance of 170 cm between the sample and the fluorescent lamps. After the vertical irradiation, luminance of each of the samples is measured at a measurement distance of 40 cm by use of a luminance meter LS-100 (manufactured by Konica Minolta Holdings, Inc.).

FIG. 6A shows the case of using the light storage material having a particle size of 150 μm (Sample 1), FIG. 6B shows the case of using the light storage material having a particle size of 3000 μm (Sample 2), and FIG. 6C shows the case of using the light storage material having a particle size of 5000 μm (Sample 3).

Similar curves are drawn in all Samples 1 to 3, and there is hardly any difference in the light emission time and the luminance between the samples. Moreover, as a result of visual sensory tests, it is determined that light is evenly emitted from the entire surface of the display plate in all the samples.

When the particles of the light storage material vary in size, it is conceivable that the larger the particle size, the larger the amount of light. However, the translucent white filling material scatters light emitted by the respective particles. Thus, it can be verified that, if the amount of the light storage material is set the same in the display devices, all the display devices show the same luminance.

Moreover, a large particle size increases gaps between the particles of the light storage material, and the light tends to be emitted in a rice-grain pattern. However, it is found out that, in the present embodiment, light scattering by the translucent white filling material makes it possible to obtain even light emission from the entire surface of the display plate.

FIG. 7A shows the case where the light storage materials having particle sizes of 3000 μm and 5000 μm are mixed by 1:1 (Sample 4), FIG. 7B shows the case where the light storage materials having particle sizes of 5000 μm, 3000 μm and 1000 μm are mixed by 5:4:1 (Sample 5), and FIG. 7C shows the case where the light storage materials having particle sizes of 5000 μm, 3000 μm and 1000 μm are mixed by 5:3:2 (Sample 6).

It is found out that similar curves are drawn in all Samples 4 to 6 and the light emission time and the luminance are approximately the same in all the samples. Moreover, as a result of visual sensory tests, it is confirmed that light is evenly emitted from the entire surface of the display plate in all Samples 4 to 6.

When the light storage materials having different particle sizes are mixed, the larger the particle size, the larger the amount of light and light emission becomes uneven. However, it is found out that, in the present embodiment, since the translucent white filling material scatters various amounts of light emitted by the light storage materials, all the display devices show the same luminance.

Moreover, it can be confirmed that Samples 4 to 6 have the same luminance as that of Samples 1 to 3 described above. Thus, the following is found out. Specifically, even if the light storage material varies in the particle size and even if the light storage materials having various particle sizes are combined, the light emitted by the respective particles of the light storage material is scattered by the translucent white filling material if the total amount of the light storage materials is the same. Thus, even light emission is achieved as a whole.

In this example, the spacer plate has the thickness of 7 mm, and a large amount of the light storage material is filled. Thus, in all Samples 1 to 6, high luminance of 10 mcd/m² or more is maintained even after a lapse of 600 minutes (10 hours). Thus, it is found out that the display devices are very bright. Note that, when the luminance is 5 or more, the devices are generally very bright and can be clearly confirmed and recognized by 10 out of 10 people. Meanwhile, in all Samples 1 to 6, the luminance is far over 5 mcd/m² even after a lapse of 800 minutes (13 hours and 20 minutes). Thus, it can be verified that sufficient brightness can be maintained all night long.

Moreover, in this example, the thickness of the spacer plate is set to 7 mm. In Sample 4, the light storage materials having the particle sizes of 5000 μm and 3000 μm are combined and planarized by use of a spatula or the like so as to correspond to the thickness of the spacer plate. Since the thickness of the spacer plate is 7 mm (7000 μm), the light storage materials having the particle sizes of 5000 μm and 3000 μm can be averagely distributed without overlapping with each other. Since the light storage materials are averagely distributed and the light emitted from the light storage materials is scattered by the filling material, the light can be evenly emitted from the entire surface of the display plate. Moreover, when the light storage material having the particle size of 1000 μm is combined with the light storage materials having the particle sizes of 5000 μm and 3000 μm, the light storage material having the particle size of 1000 μm is filled so as to fill up gaps between the light storage materials having the particle sizes of 5000 μm and 3000 μl. Thus, the total amount of the light storage materials in the light emitting layer can be further increased. As a result, a display device having high luminance and a long light emission time can be provided.

### EXAMPLE 2

Next, after a display device including no light emitting element provided therein is manufactured by use of the manufacturing method described above, a test is conducted for luminance in the case where the display device is warmed. As a light storage material, a blue color forming light storage material EZCM (manufactured by EZ BRIGHT CORPORATION) having a particle size of 150 μm is prepared. Thereafter, two samples of the same display device are prepared.

A filling material to be used, a size of the display device and the like are the same as those in Example 1.

After light irradiation is performed in the same manner as Example 1, luminance of each of the samples is measured.

For one of the samples (Sample 11), vertical irradiation with a fluorescent lamp is performed while maintaining a state where the sample is warmed to 40° C. by warm air, the sample is left at room temperature after the irradiation, and a luminance test is conducted. For the other sample (Sample 12), irradiation with a fluorescent lamp is performed while leaving the sample at room temperature without warming the sample, and a luminance test is conducted.

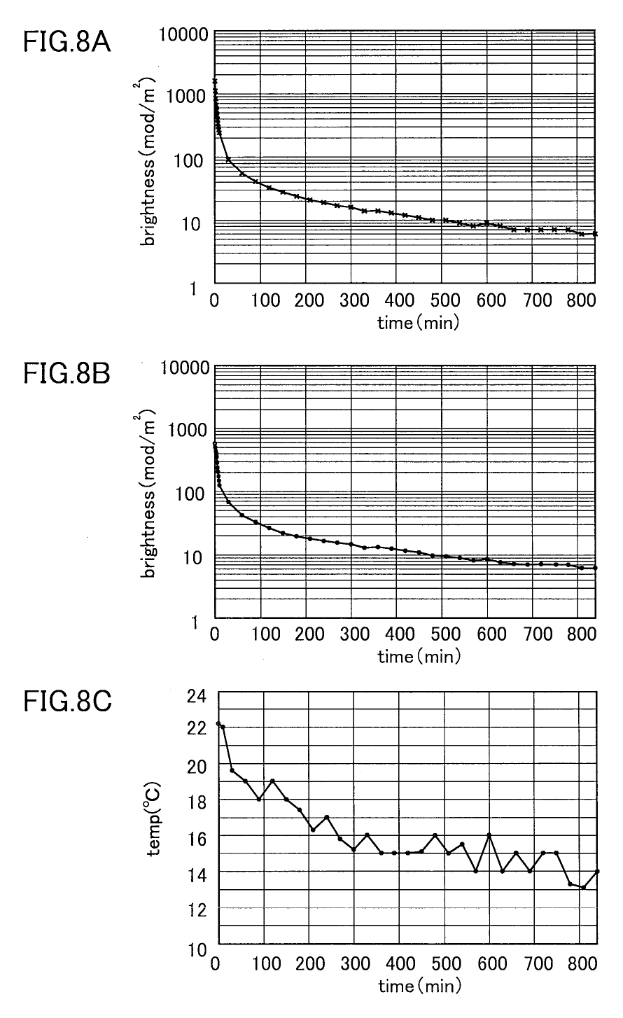

FIG. 8A shows a relationship between luminance and time in Sample 11, FIG. 8B shows a relationship between luminance and time in Sample 12, and FIG. 8C shows a relationship between room temperature and time at which and for which the luminance test is conducted.

Sample 11 has high luminance up to about 300 minutes after start of the test compared with Sample 12. It is found out that, since Sample 11 is warmed to 40° C., luminous efficiency is enhanced. Particularly, when measurement is started, Sample 12 has luminance of about 600 mcd/m². Meanwhile, Sample 11 has very high luminance of about 1500 mcd/m².

In an emergency such as a blackout, a viewer is required to be able to perform evacuation guidance by instantly recognizing the display device. It is found out that the present embodiment is effective in evacuation guidance and the like since the light emitting layer is warmed and thus initial luminance is particularly high.

As shown in FIG. 8C, although room temperature of a laboratory used for luminance measurement is low, Sample 11 has high luminance because of warming and is also effective in such a place with a low temperature. Note that Sample 11 and Sample 12 have approximately the same luminance after a lapse of 300 minutes. This is considered to be because temperatures of the both samples are set the same. Considering that a temperature drop in a substance is gradual in a high temperature state, time required for Samples 11 and 12 to have the same luminance is considered to be further extended in a high room temperature state.

In this example, the tests are conducted without providing the light emitting element in the display device. However, in the display device according to the present embodiment, the light guide plate and the light emitting element housing part are closely attached to each other to form an enclosed space. Thus, the ambient temperature is sufficiently increased in this space by heat generated by the light emitting element. Therefore, the light emitted by the light emitting element can be sufficiently stored by the light storage material. Moreover, the light storage material can be warmed to about 40° C. Thus, the display device is considered to show the same luminance as that described above or higher. Furthermore, the light emitting element housing part and the light guide plate are closely attached to each other to form the enclosed space. Thus, it is considered to be possible to maintain light emission with higher luminance by keeping the light emitting layer warm by the increased ambient temperature in the space.

Moreover, in the present embodiment, as long as the power is supplied to the light emitting element, the light storage material emits light while sufficiently storing light emitted by the light emitting element. Since the light emitting layer is maintained in a state of being warmed to about 40° C. by the heat generated by the light emitting element, the luminance of light emission from the light emitting layer can be constantly maintained to be the initial luminance described above. Furthermore, although the light from the light emitting element partially passes through the light guide plate and the light emitting layer, the light is combined with the light emitted from the light emitting layer. Thus, the display device having very high luminance is achieved.

The present embodiment has an advantage that light can be evenly emitted from the entire surface of the display plate since light emitted by the particles of the light storage material is scattered by the translucent white filling material.

Moreover, according to the present embodiment, the light emitting layer can evenly emit light from the entire surface of the display plate as described above. Hence, the light emitting layer can be used as the backlight.

Furthermore, according to the present embodiment, even if the light emitting layer includes light storage materials having various particle sizes, various amounts of light emitted from the respective light storage materials are scattered by the translucent white filling material. Thus, there is an advantage that display devices having the same luminance can be obtained if the total amount of the light storage materials contained in the light emitting layer is the same.

Furthermore, according to the present embodiment, a caulking material or a sealing material, which has elasticity even when cured, is used as the filling material. Moreover, high elasticity and air tightness of the filling material maintains adhesion between the filling material and the light storage material even if the display device undergoes a stress or a thermal change. Hence, no gaps are formed and light refraction is set constant. Consequently, light emission with constant luminance is realized.

Furthermore, according to the present embodiment, a white plate is used as the reflector plate to enhance luminance by reflecting the light emitted from the light storage material. Accordingly, the display device having high luminance can be provided.

Furthermore, according to the present embodiment, the mechanical strength is enhanced by using hard resin such as polycarbonate resin or tempered glass and the like as the display plate, the spacer plate and the reflector plate. Thus, use of the display device in places undergoing impact, such as a hallway in a building or a passageway at a station, is achieved.

Furthermore, according to the present embodiment, the light emitting layer is not required to have mechanical strength since the light emitting layer is mechanically supported by the display plate, the spacer plate and the reflector plate. Hence, a considerable amount of the light storage material can be mixed in the light emitting layer. Moreover, since the space is filled with the filling material, a light emission amount can be significantly improved.

Furthermore, according to the present embodiment, the light storage material in the light emitting layer formed to be sufficiently thick is allowed to constantly store light by use of the light emitting element from a back side of the light emitting layer. Thus, a display device which constantly enables light emission with constant luminance can be provided.

Furthermore, according to the present embodiment, light and heat generated by the light emitting element allow constant light storage by the light storage material. Accordingly, there is an advantage that, even when power supply is shut off such as in an emergency, the light storage material instantly emits light to make the display plate visible.

Furthermore, according to the present embodiment, an enclosed space is formed by the light emitting element housing part and the light guide plate, and the light emitting layer is warmed by increasing an ambient temperature in the light emitting element housing part by utilizing the heat generated by the light emitting element. Hence, compared with the case of light storage only by use of light, the light emitting layer has high luminous efficiency and light emission with high luminance is realized.

Furthermore, according to the present embodiment, the display device has a configuration in which the light emitting layer is sandwiched between the first and second display plates. Thus, there is an advantage that both of the display plates are made visible.

According to the manufacturing method of the present embodiment, the mixture of the light storage material and the filling material is merely filled in the space formed by the reflector plate or the first display plate and the spacer plate having a predetermined thickness. Thus, the light emitting layer having a predetermined thickness can be easily obtained.

Moreover, according to the manufacturing method of the present embodiment, viscosity of the filling material maintains the particles of the light storage material in a state of being covered with the filling material and averagely dispersed. Accordingly, there is an advantage that the display device in which the particles of the light storage material are averagely dispersed can be easily provided.

Furthermore, according to the manufacturing method of the present embodiment, since the filling material with excellent air tightness is used, no air enters the light emitting layer in preparation thereof. As a result, the light emitting layer without any gaps therein can be obtained.

Furthermore, according to the manufacturing method of the present embodiment, the viscosity of the filling material maintains the particles of the light storage material in the averagely dispersed state as described above. Moreover, in the above state, the filling material is air-dried and cured. Thus, there is an advantage that a display device having high luminance can be provided by filling a large amount of the light storage material by use of a thick spacer plate and forming a light emitting layer having a much larger thickness.

What is claimed is:

1. A display device using a light storage material, comprising:
a light-transmitting display plate having a predetermined pattern that is formed on the light-transmitting display plate and made of a material having a transmittance different from the light-transmitting display plate;
a light-reflecting plate;
a spacer plate disposed between the light-transmitting display plate and the light-reflecting plate; and
a light emitting layer disposed in a space defined by the light-transmitting display plate, the spacer plate and the light-reflecting plate and comprising particles of the light storage material and a body of a filling material having the particles mixed therein, the light emitting layer being configured to operate as a backlight for illuminating the predetermined pattern,
wherein the light-reflecting plate is configured to reflect light emitted from the light emitting layer toward the light-transmitting display plate.

2. The display device of claim 1, wherein the light-reflecting plate comprises a white plate.

3. The display device of claim 1, wherein the filling material is made of a white material so as to scatter light emitted from the light storage material.

4. The display device of claim 3, wherein the filling material comprises a caulking material or a sealing material so as to cover the light storage material.

5. The display device of claim 1, wherein the light-transmitting display plate, the light-reflecting plate and the spacer plate are made of a resin or a glass so as to mechanically support a large amount of the light emitting layer that is not able to maintain a posture thereof by itself.

6. The display device of claim 1, further comprising a light guide plate disposed between the light emitting layer and the light-reflecting plate, a housing compartment disposed between the light guide plate and the light-reflecting plate, a light emitting element housed in the housing compartment, wherein the light emitting layer has approximately the same size as the housing compartment.

7. A display device using a light storage material, comprising:
a first light-transmitting display plate;
a second light-transmitting display plate;
a spacer plate disposed between the first and second light-transmitting display plates; and
a light emitting layer disposed in a space defined by the first and second light-transmitting display plates and the spacer plate and comprising particles of the light storage material and a body of a filling material having the particles mixed therein,
wherein a predetermined pattern made of a material having a transmittance different from the first and second light-transmitting display plates is formed on one of or both of the first and second light-transmitting display plates, and the light emitting layer is configured to operate as a backlight for illuminating the predetermined pattern.

8. A method of manufacturing a display device using a light storage material, comprising:
attaching a spacer plate to a first plate so as to form an open box;
filling the open box with a mixture of the light storage material and a resin material that maintains elasticity after curing;
attaching a second plate to the spacer plate; and
curing the resin material.

9. The method of claim 8, further comprising dispersing particles of the light storage materials in the resin material prior to the filling of the open box.

10. The method of claim 8, wherein the first plate comprises a light-reflecting plate, and the second plate comprises a light-transmitting display plate.

11. The method of claim 8, wherein the first plate comprises a light-transmitting display plate, and the second plate comprises another light-transmitting display plate.
